(19) United States
(12) Patent Application Publication
(10) Pub. No.: US 2003/0073230 A1
(43) Pub. Date: Apr. 17, 2003

(54) Liquid handling system and method

(76) Inventor: Can D. Akyuz, Somerville, MA (US)

Correspondence Address: FISH & RICHARDSON PC, 225 FRANKLIN ST, BOSTON, MA, 02110, US

(21) Appl. No.: 10/161,211

(22) Filed: May 31, 2002

Related U.S. Application Data
(60) Provisional application No. 60/295,195, filed on Jun. 1, 2001.

(51) Int. Cl. G01N 35/04

(52) U.S. Cl. 435/287.3; 73/864.85

(57) ABSTRACT

The storage medium stores multiple samples of liquid and is movable for providing those samples from a loading position to a position where the samples can be provided to an analysis system.

### CROSS REFERENCE TO RELATED APPLICATION

This application claims priority from provisional application Serial No. 60/295,195, filed on Jun. 1, 2001, which is incorporated herein by reference.

### BACKGROUND OF THE INVENTION

U.S. Pat. No. 6,147,344, incorporated herein by reference, describes a system and method referred to as the Automated Ligand Identification System (ALIS) for screening proteins against libraries of small organic molecules for the discovery of small molecule ligands that bind to a target protein. ALIS allows each member of a library of potential ligands to be screened in parallel with every other member of that library. The protein is combined with the molecules, incubated, and provided to a high pressure liquid chromatography (HPLC) system. The resulting increased screening throughput is advantageous over approaches that require library members to be screened individually.

A current standard ALIS screening system utilizes sample volumes of 10 uL. These samples are prepared and held in standard 250 uL autosampler vials until they are ready to be loaded into the HPLC system. When ready, the samples are drawn out of the vials with a needle and injected into a sample loop mounted on a two-way valve. The valve is then turned to connect the sample to the HPLC.

### SUMMARY OF THE INVENTION

The embodiment of the present invention reduces sample volumes of liquid biological materials, preferably to 100 nL, before being provided to an analytical system, such as an HPLC system. To prepare and hold such low volumes of liquid, a storage medium with microbores is used. Small quantities, such as 50 nL each, of library and protein are separately injected as droplets into openings in the storage medium to create the screening samples. The library and protein mix when the separate droplets are combined in the opening in the medium and are held by capillary forces. The mixed samples are incubated, e.g., for 30 minutes, at room temperature in a humidified chamber to prevent sample evaporation, and then loaded into the analytical system.

The medium is preferably a disk with a number of microbores arranged circumferentially near the edge of the disk. The disk rotates such that each microbore moves from a fill position where liquid is inserted, through one or more intermediate positions, to a load position where liquid is provided to the analytical system. The time it takes for a sample to go from the fill position to the load position is preferably set to be the incubation time.

The embodiment of the present invention preferably can provide reduced protein consumption because many proteins are obtained from biological sources and are available in minimal quantities. Therefore, it is desirable to minimize the quantity of protein required for each screen. The embodiment can also provide full integration and automation of all components, thereby combining separate processes into a single streamlined system designed to optimize the conditions for screening proteins against small molecule library mixtures.

Other features and advantages will become apparent from the following detailed description, drawings, and claims.

### BRIEF DESCRIPTION OF THE DRAWINGS

FIG. 1 shows a series of side views of a storage medium from an empty state to a mixed sample state.

FIG. 2 illustrates side views of a mixed sample as the sample is transferred from the medium.

FIG. 3 is a schematic of an automated in-line system illustrating loading and coupling a medium in stages.

FIG. 4 is a cross-sectional view of a storage medium and microbore with tubing as a variation of the coupling shown in FIG. 2.

### DETAILED DESCRIPTION

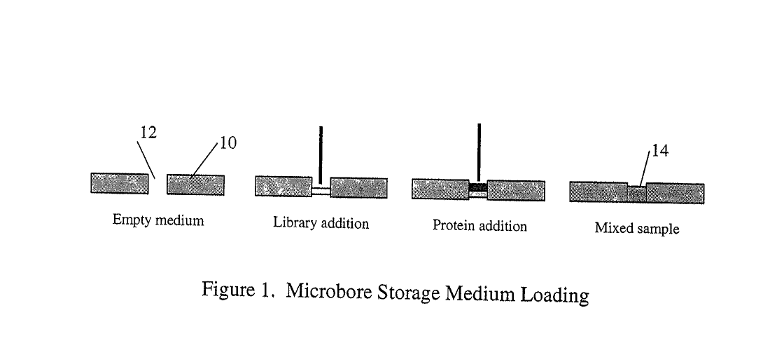

Referring to FIG. 1, a storage medium 10, such as a disk with microbores 12, is loaded with a library of small molecules and protein, each in liquid form, preferably using low volume gas tight syringes. These liquids are held in the microbore with capillary forces. The syringes can be manipulated and loaded manually or by using automated stepping motors. Automation is preferable both for accuracy of sample volume and syringe positioning with respect to the storage medium. As shown in FIG. 1, the library and then protein (or vice versa) are introduced into microbore 12 to produce a mixed sample 14.

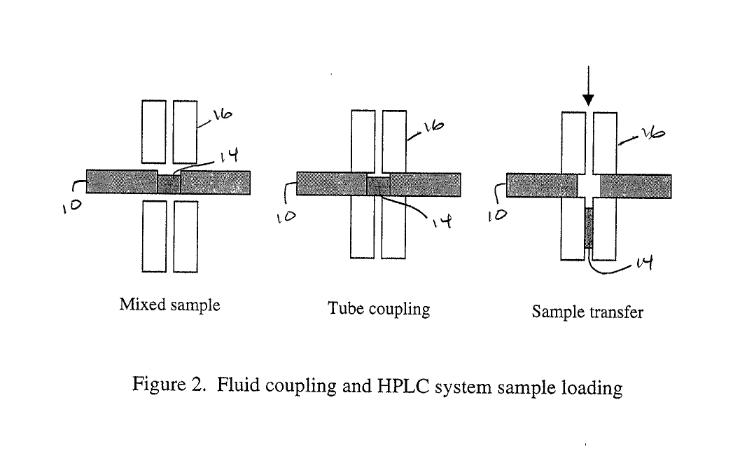

Referring to FIG. 2, After an incubation time, the microbore storage medium is coupled to an HPLC system to load samples for screening in a manner described in the incorporated patent. The coupling from the storage medium to the HPLC system is preferably achieved by compressing HPLC liquid tubing 16 directly onto faces of the storage medium where microbore 12 are located. Compression pressure creates a seal between storage medium 10 and tubing 16, allowing transfer of the samples into the HPLC system with minimal loss. Liquid sample 14 is pushed (or it could be pulled) from microbore 12 with pressure, such as by introducing a screen buffer to push the sample. This embodiment of the present invention thus allows the transfer of very small quantities to an analysis machine, such as an HPLC system, and in an automated manner.

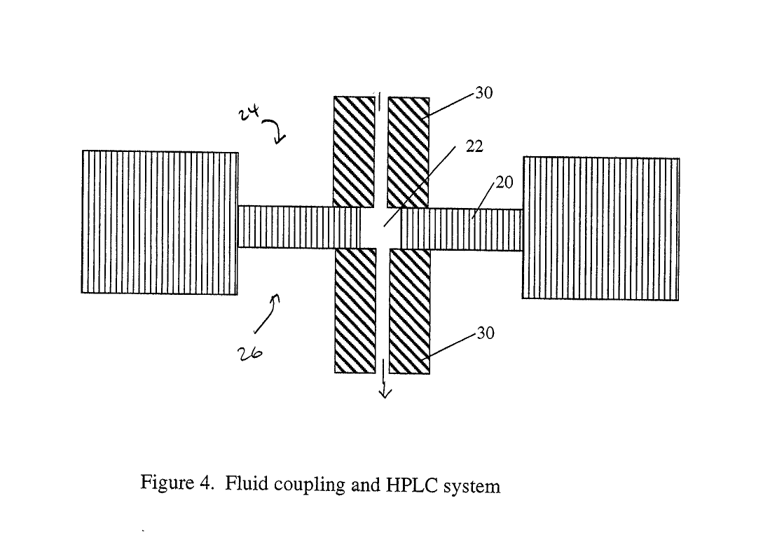

Referring to FIG. 4, a storage medium 20 can have recessed portions 24 and 26 with a microbore 22 therebetween. Medium 20 is preferably made of a firm material that has some compressibility, such as PTFE, while tubing 30 used to move a sample out of microbore 20 is made of a material that is preferably more rigid than medium 30. This relationship of the relative rigidity helps to create a tight seal between tubing 30 and medium 20.

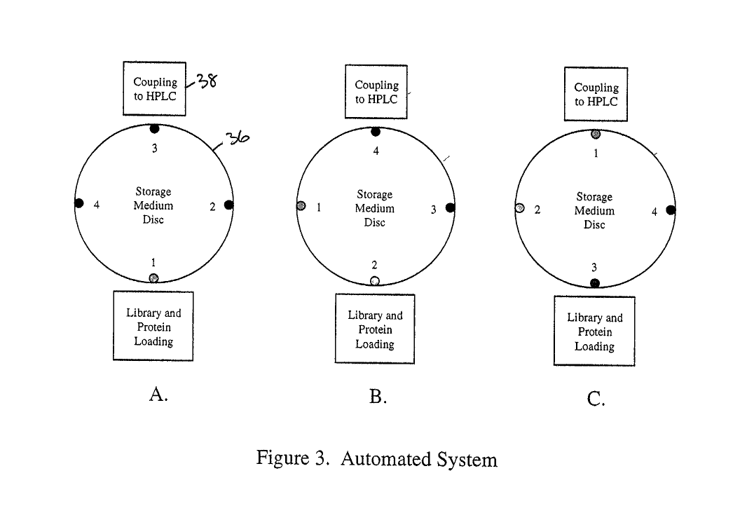

Referring to FIG. 3, system automation is achieved with an inline system in which samples are prepared and screened sequentially and continuously. Microbore holes are fabricated around a storage medium in the shape of the disk 36 and preferably located near the edge. The disk is rotated with a motor, such as with direct drive or a belt drive, from one position to the next for loading, incubating, and transferring the sample from the loading stage to an analytical system, such as the HPLC system. As shown in FIG. 3A, library and protein are loaded into disk 36 at position 1. Disk 36 is rotated clockwise one step and library and protein are loaded at position 2, while the sample at position 1 is incubating (FIG. 3B). With another step in the rotation of disk 36, the incubated sample at position 1 is loaded via a coupling 38 into an HPLC or other analysis system while the sample in position 2 is incubated and a new sample is injected into disk 36 at position 3 (FIG. 3C). Operation in this manner results in a pipelined system for sample preparation, incubation, and screening.

While only a few microbores are shown, there would typically be many openings. The time from loading to coupling to the HPLC system is preferably set to be the desired incubation time. For example, if the disk has 32 openings, a sample would need to be moved sixteen times from loading to coupling to the HPLC system. Assuming a desired incubation time of about thirty-two minutes, each step would be designed to take two minutes so that the incubation is performed while the sample is moved. As indicated above, this means that the process can happen in an automated manner. While preferably done in a continuous inline manner, such continuous processing is not necessary and some or all portions of the processing could be done manually or the system could be stopped for some extended period of time as needed, such as for incubation. The system and process are said to be continuous in that the samples can be loaded and carried to the analysis system in a pipelined manner, and not that the storage medium is necessarily moving all the time.

The embodiment of the present invention has been described in terms of library and protein, but can include other biological samples of materials that need to be combined in quantities of about 100 nL or less. While the system is described in conjunction with an HPLC, other types of the analysis equipment can be used in which the sample is transferred from the medium to some other device for such analysis.

Having described embodiments of the present invention, it should be apparent that modifications can be made without departing from the scope of the invention as defined by the appended claims. For example, while the storage medium has been shown as a circular, rotatable disk, the medium could have other shapes and be rotated, such as an octagon shape or even a square shape, and rather than being rotated, the medium could be moved in a linear manner. While protein and ligands are described as the liquids, other biological samples could be introduced. While the storage medium has been described as moving to locations where samples are loaded and then transferred, the nozzles for inserting a sample and the tubing for extracting a sample could be movable with a stationary storage medium.

What is claimed is:

1. A processing system for providing a liquid sample to an analysis system comprising a storage medium for receiving and holding liquid samples of about 100 nL or less, the storage medium being movable to allow a first sample to be loaded at a loading location and then provided to a transfer location for transfer to the analysis system while a second sample is loaded at the loading location in an automated manner.

2. The system of claim 1, wherein the storage medium holds samples with capillary action in bores.

3. The system of claim 1, wherein the samples are a combination of biological materials.

4. The system of claim 1, wherein the storage medium has a plurality of bores.

5. The system of claim 4, wherein a sample can be loaded into the loading position at the same time another sample is transferred to the analysis system.

6. The system of claim 5, further comprising tubing for transferring samples from the transfer position to the analysis system.

7. The system of claim 1, further comprising tubing for transferring samples from the transfer position to the analysis system.

8. The system of claim 1, wherein the storage medium is moved such that the time it takes for a sample to go from the loading location to the transfer location is a desired incubation time.

9. A method comprising:
loading a first sample of biological material into a location of a storage medium that can hold multiple samples;
moving the storage medium;
loading a next sample of biological material into a next location of the storage medium;
repeating the moving and loading a next sample as desired;
transferring samples in an automated manner from the locations to an analysis system for analyzing the sample.

10. The method of claim 9, wherein the analysis system includes a high pressure liquid chromatography system.

11. The method of claim 9, wherein the storage medium is moved such that the time it takes from the first sample being loaded to being transferred to the analysis system is a predetermined time based at least in part on an incubation time for the first sample.

12. The method of claim 9, wherein the samples are no more than at 100 nL each.

13. The method of claim 9, wherein the biological material includes a protein and a library of small molecules combined such that one or more of the small molecules bind to the protein.

14. The method of claim 9, wherein the storage medium includes a rotatable disk.

15. A method comprising:
loading samples of biological material into locations of a storage medium that can hold multiple samples; and
transferring samples from the locations to an analysis system for analyzing the sample after a delay for incubation;
wherein the loading and transferring are performed in an automated inline manner.

16. The method of claim 15, wherein the analysis system includes a high pressure liquid chromatography system.

17. The method of claim 15, wherein the samples are no more than 100 nL each.

18. The method of claim 15, wherein the samples include a protein and a library of small molecules combined such that one or more of the small molecules bind to the protein.

19. The method of claim 18, wherein the samples are no more than 100 nL each.

20. The method of claim 15, wherein the storage medium includes a disk.
